(19) United States
(12) Patent Application Publication
(10) Pub. No.: US 2026/0319507 A1
(43) Pub. Date: Oct. 15, 2026

(54) SYSTEM AND METHOD FOR DETECTING GUESTS IN RESTRICTED AREAS

(71) Applicant: Universal City Studios LLC, Universal City, CA (US)

(72) Inventors: James Joseph Childs, JR., Winter Garden, FL (US); Kevin Weekes, Ocoee, FL (US)

(21) Appl. No.: 19/467,486

(22) Filed: Feb. 2, 2026

Related U.S. Application Data
(60) Provisional application No. 63/755,784, filed on Feb. 7, 2025.

(51) Int. Cl. G05D 1/622; G01S 13/08; G01S 13/87; G01S 13/93; G05D 105/30; G05D 107/00; G05D 111/30

(52) U.S. Cl. CPC G05D 1/622; G01S 13/08; G01S 13/872; G01S 13/93; G05D 2105/32; G05D 2107/87; G05D 2111/30

(57) ABSTRACT

Guest detection systems and methods are described herein which may be used in any suitable venue, such as any suitable entertainment venue. The guest detection system may include a computing system, a ride vehicle, and at least one radar device or system. In certain such implementations all or part of the radar (e.g., emission and sensing structures) may be attached to the ride vehicle. The radar in such approaches may be configured to emit a radar beam corresponding to or defining a radar field. The radar may be positioned and oriented such that the radar field monitors a restricted area where guests are not permitted to be during operation of the ride vehicle and/or attraction

### CROSS-REFERENCE TO RELATED APPLICATION

This application claims priority to and the benefit of U.S. Provisional Application No. 63/755,784, entitled “A SYSTEM AND METHOD FOR DETECTING GUESTS IN RESTRICTED AREAS” and filed Feb. 7, 2026, which is incorporated by reference herein in its entirety for all purposes.

### TECHNICAL FIELD

The invention relates generally to systems and methods for protecting guest safety on an amusement park attraction. More particularly, it relates generally to a system and a method for detecting if a guest is attempting to engage in unsafe activities or disembark a ride vehicle while the attraction is in operation.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Various entertainment venues (e.g., theme and amusement parks, arcades, carnivals, fairs) typically include rides or other attractions with which a guest can interact or ride. By way of example, in certain such attractions a guest to the park may enter a tracked or free-moving “vehicle” to participate in the attraction. At the conclusion of a set time or of a course being completed, the attraction is concluded and the guest exits the vehicle. However, during the course of the attraction (e.g., ride), the guest is typically intended to stay within the vehicle and, in fact, it may be unsafe for the guest to exit prematurely.

Various systems have been used to determine whether a guest is seated while a ride is in operation and whether a guest has disembarked from the ride vehicle while the attraction is in operation. However, these systems can be expensive, complicated to configure and operate, and ineffective against determined guests. Additionally, these systems often do not provide sufficient early detection or warning, potentially resulting in the guest disembarking from the ride vehicle before the systems can take action to stop the ride vehicle or otherwise protect the guest's safety. Therefore, an inexpensive and simple system and a method which can detect if a guest is attempting to engage in unsafe activities or disembark a ride vehicle before the guest does so would be useful.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, the system of the present disclosure includes a ride vehicle, at least one radar, and a computing system configured to communicate with the radar. The radar is configured to emit a radar field and is positioned and oriented such that the radar field monitors a restricted area. The computing system is configured to detect whether there is a breach in the radar field and adjust an operation of the ride vehicle in response to a detected breach in the radar field.

In an embodiment, the method of the present disclosure includes first activating, via a processor of a computer system, a radar, wherein the radar is configured to emit radio waves as a radar field, monitoring, via the processor, the radar field for a breach, determining, via the processor, the radar field is breached by an object, and adjusting, via the processor, an operation of a ride vehicle based on the determination.

In an embodiment, the system of the present disclosure includes a ride vehicle, a first radar coupled to the ride vehicle, a second radar coupled to the ride vehicle, and a computing system in communication with the first radar and the second radar. The first radar is configured to emit a first radar field, and the second radar is configured to emit a second radar field. The computing system is programmed to detect whether there is a breach in at least the first radar field or the second radar field and adjust an operation of the ride vehicle when the breach is detected.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of a guest detection system, in accordance with an embodiment of the present disclosure;

FIG. 2 is a side view of the guest detection system with at least one radar coupled to back of the ride vehicle, in accordance with an embodiment of the present disclosure;

FIG. 3 is a perspective view of the guest detection system with at least one radar coupled to back of the ride vehicle, in accordance with an embodiment of the present disclosure;

FIG. 4 is a perspective view of the guest detection system with at least one radar coupled to side of the ride vehicle, in accordance with an embodiment of the present disclosure;

FIG. 5 is a depiction of the operation of the guest detection system, in accordance with an embodiment of the present disclosure; and

FIG. 6 is a flowchart of the operation of the guest detection system, in accordance with an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features or to signify that the respective embodiments are different embodiments.

The present disclosure is generally related to guest detection systems and methods that may be used in any suitable venue, such as any suitable entertainment venue (e.g., amusement park, fair, arcade). The guest detection system may be implemented within the venue, such as being part of or in communication with the attraction. The guest detection system may include a computing system, a ride vehicle, and at least one radar device or system. In such an embodiment, all or part of the radar (e.g., emission and sensing structures) may be coupled to the ride vehicle. The radar in such an embodiment may be configured to emit a radar beam corresponding to or defining a radar field, such as continuously or periodically, during operation of the ride vehicle. The radar may be positioned and oriented such that the radar field monitors a restricted area where guests are not permitted to be during operation of the ride vehicle and/or attraction.

The guest detection system may monitor the radar field for intrusions into the restricted area or space by an object, such as a guest, a portion of a guest (e.g., arm or head), or item held or discarded by a guest) entering the restricted area during operation of the ride vehicle. If such an intrusion is detected, the guest detection system may determine whether the detected (i.e., intruding) object is within specified thresholds. Based on the comparison to thresholds, the guest detection system may consider the radar field to have been breached by the object. Conversely, in other embodiments, no threshold may be employed and any detection or intrusion event may be deemed a breach of the restricted area. The computing system may generate an alert in response to a breach. The guest detection system may adjust the operation of the ride vehicle or the attraction in response to the breach, such as by stopping the ride vehicle.

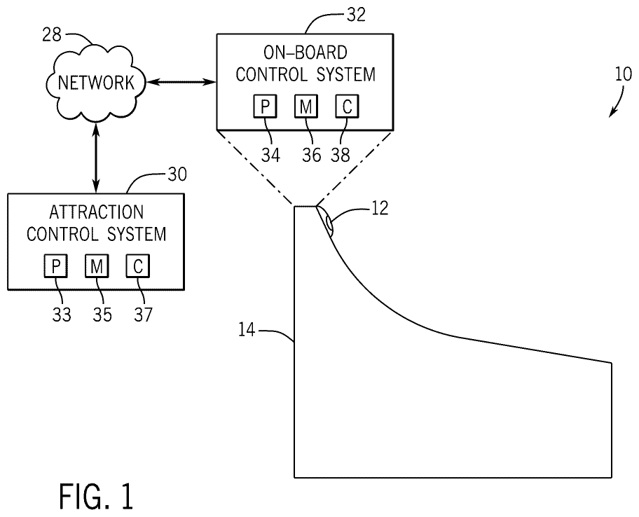

With the foregoing in mind, FIG. 1 is a schematic illustration of one embodiment of a guest detection system 10. The guest detection system may be implemented on an attraction or, more generally, at a venue at which the attraction is present. The attraction may comprise a plurality of ride vehicles 14. As shown, the guest detection system 10 may include an attraction control system 30 (e.g., processing system) that includes a processor 33, a memory 35, and a communication device 37. The guest detection system 10 may also include the ride vehicle 14 and at least one radar 12. In some embodiments, the at least one radar 12 may be coupled to the ride vehicle 14.

The ride vehicle 14 may include or otherwise be in communication with a control system 32 (e.g., an on-board control system) that includes a processor 34, a memory 36, and a communication device 38. Components of the control system 32, if present as part of the attraction and/or ride vehicle (i.e., “on-board”), may be enclosed or supported within one or more housings.

The on-board control system 32 may be communicatively coupled with the ride vehicle 14, the at least one radar 12, and the attraction control system 30 via a wired and/or wireless network (e.g., one or more networks, such as short-range and/or long-range networks). In some embodiments, the ride vehicle 14 may be communicatively coupled with the at least one radar 12 and/or attraction control system 30 via the network 28. In any case, the on-board control system 32, the ride vehicle 14, the at least one radar 12, and/or the attraction control system 30 may communicate to provide data, control signals, and so forth to facilitate techniques disclosed herein.

The processors 33, 34 may be configured to process instructions stored in respective memories 35, 36 to operate the guest detection system 10. The processors 33, 34 may include hardware-based processors (e.g., microprocessors, CPUs, GPUs) that each include one or more cores. The processors 33, 34 may include general purpose processors, special purpose processors, or both.

The memory 35, 36 may store information, including the instructions, within the guest detection system 10. In certain embodiments, the memory 35, 36 includes one or more computer-readable media. The memory 35, 36 may include any suitable number of volatile memory units and/or non-volatile memory units. The memory 35, 36 may include read-only memory, random access memory, or both. In certain embodiments, the memory 35, 36 may be configured to provide (e.g., persistent) mass storage for the guest detection system 10.

It should be appreciated that the memory 35, 36 may include one or more computer-readable storage media (CRSM). The CRSM may provide storage of the instructions (e.g., processor-executable instructions) describing data structures, processes, applications, programs, other modules, and/or other data for the operation of the guest detection system 10. In certain embodiments, the CRSM may include a data store that provides storage of the instructions and/or other information in a non-transitory format.

The communication devices 37, 38 may include transceiver devices configured to send and receive communications over the network 28 using any suitable network protocol. The network 28 may include public networks such as the Internet, private networks such as an institutional or personal intranet, or any combination of private and public networks. The network 28 may include any suitable type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In certain embodiments, the communications between computing devices (e.g., the attraction control system 30 and the on-board control system 32) may be encrypted or otherwise secured. For example, the communications may employ one or more public or private cryptographic keys, ciphers, digital certificates, or other credentials supported by a security protocol.

The attraction control system 30 and the on-board control system 32 may include one or more computing devices of any suitable type. The computing device(s) may include, but are not limited to: a programmable logic controller, a personal computer, a smartphone, a tablet computer, an automotive computer, a desktop computer, a laptop computer, a notebook computer, a network computer, a server computer, a mainframe computer, a distributed computing device (e.g., a cloud computing device), a microcomputer, a system on a chip (SoC), a system in a package (SiP), and so forth. Although examples herein may describe the computing device(s) as physical device(s), certain embodiments are not so limited. In some examples, the computing device(s) may include one or more of a virtual computing environment or a virtual machine executing on one or more physical computing devices. In some examples, two or more computing devices may include a cluster, cloud, farm, or other grouping of multiple devices that coordinate operations to provide load balancing, failover support, parallel processing capabilities, shared processing resources, shared storage resources, shared networking capabilities, and/or other aspects. Accordingly, the attraction control system 30 and the on-board control system 32 may be collectively referred to herein as a computing system (e.g. a processing system), and it should be appreciated that any of the processing operations described herein may be carried out by the attraction control system 30, by the on-board control system 32, and/or distributed between the attraction control system 30 and the on-board control system 32 in any manner to operate the guest detection system 10. Indeed, certain operations described herein by way of example as being performed by components of the attraction control system 30 (e.g., the processor 33) may instead be performed by the on-board control system 32 (e.g., the processor 34), and vice versa.

In certain embodiments, the guest detection system 10 may include and/or utilize a guest detection application (e.g., software application), which may be stored in the memory 35 of the attraction control system 30. In particular, the guest detection system 10 may utilize the guest detection application to provide a user interface for displaying an alert if one or more guests are or are not in a restricted area and other relevant information. A software application (e.g., the guest detection application, which may also be referred to a program, software, script, or code) may be written in any appropriate form of programming language, including compiled or interpreted languages, and it may be deployed in any appropriate form, including as a standalone program or as a module, component, subroutine, or other unit suitable for use in a computing environment. The software application may be deployed to be executed on one computing device or on multiple computing devices that are located at one site or that are distributed across multiple sites and interconnected by the network 28.

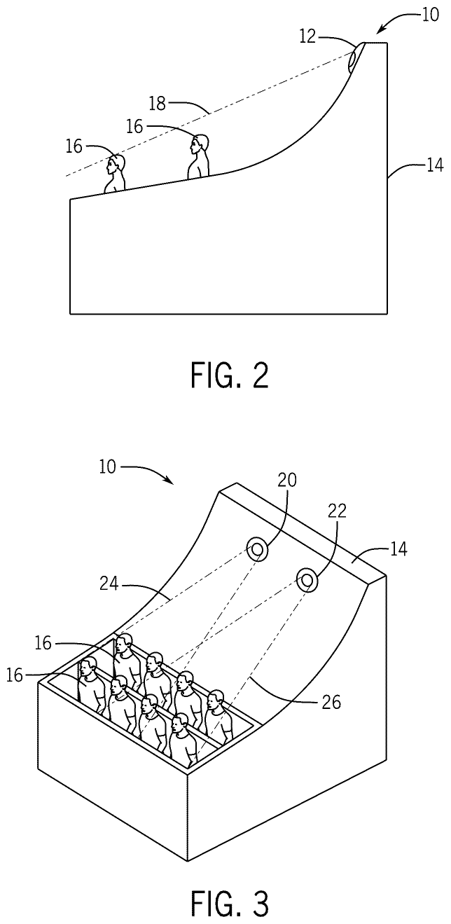

FIG. 2 is a side view of a ride vehicle 14 in accordance with one embodiment of the guest detection system 10. The guest detection system may include a ride vehicle 14 and at least one radar 12. The ride vehicle may be configured to hold one or more guests 16. In some embodiments, the ride vehicle is free moving (e.g., not on a fixed track). For example, the ride vehicle 14 may sit on a scissor lift to simulate movement. In other embodiments, the ride vehicle 14 moves along a fixed track or defined course. A ride vehicle 14 may be individually controlled or collectively controlled with other ride vehicles of the plurality of rides vehicles of the attraction.

The at least one radar 12 may be coupled or integral to the ride vehicle 14. In the pictured embodiment, the radar 12 may be coupled to a back interior wall of the ride vehicle 14. However, it should be appreciated that the radar 12 may be coupled to a front interior wall of the ride vehicle 14, to a top of the back wall of the ride vehicle 14, or in any other configuration that allows the radar 12 to detect if the one or more guests 16 are in a restricted area or space (e.g., breaking a vertical and/or horizontal plane that may be indicative of a guest standing or attempting to exit the ride vehicle 14 while in motion or otherwise during the course of the ride).

The radar 12 may emit radio waves to define a radar field 18 in a flat wedged shape (i.e., expanding outward from the radar device). The radar 12 may emit the radio waves defining the radar field 18 continuously, when the attraction is in operation, when the ride vehicle 14 is in operation, or as attraction staff requires. Alternatively, as noted herein emission of the radio waves by the radar 12 may be periodic or otherwise non-continuous (e.g., every 0.5 seconds, every second, every 2 seconds, every 5 seconds, and so forth). The radar 12 may be positioned and oriented such that the radio waves corresponding to the radar field 18 facilitate monitoring of the restricted area. The computing system may determine there is the breach in or intrusion into the radar field 18 when a guest 16 is present, entirely or in part, in the restricted area. The restricted area does not include the interior of the ride vehicle 14. In certain embodiments the guest detection system 10 does not monitor the interior of the ride vehicle 14 as that is where the guests are supposed to be present, and thus generally not worthy of alert. The restricted area may comprise any area where guests 16 are not permitted to be during operation of the ride vehicle 14. For example, if it is unsafe to stand during the operation of the ride vehicle 14, the restricted area may comprise a flat plane approximately one foot above the average height of a seated guest wherein the radar field is breached if a guest 16 stands during the operation of the ride vehicle 14. Additionally and/or alternatively, the restricted area may comprise an area outside of the ride vehicle 14 indicative of whether a guest has exited the ride vehicle.

In some embodiments, the ride vehicle 14 may include multi-level seating. In such an embodiment, the radar 12 may be positioned and oriented such that the radar field 18 is emitted at an angle to account for the change in height between levels of multi-level seating. For example, if the multi-level seating is sloped at a 20-degree angle, the radar 12 may be oriented to emit radio waves forming the radar field 18 along the same 20-degree angle slope. That is, the radar field 18 may be parallel to the slope of the multi-level seating. As such, the radar field 18 may be emitted at a consistent height relative to the height of each level of the multi-level seating.

FIG. 3 is a perspective view of one embodiment of the guest detection system 10. In the pictured embodiment, the guest detection system 10 may include a ride vehicle 14, a first radar 20 coupled to the ride vehicle 14, and a second radar 22 coupled to the ride vehicle 14. The first radar 20 may emit radio waves corresponding to a first radar field 24 and the second radar 22 may emit radio waves corresponding to a second radar field 26. In some embodiments, the first radar 20 may emit the first radar field 24 at a different height than the second radar 22 emits the second radar field 26. In this manner, the second radar 22 may act as a failsafe if the first radar 20 is inoperable and vice versa. In other embodiments, the first radar 20 may emit the first radar field 24 at the same height that the second radar 22 emits the second radar field 26 such that the first radar field 24 and the second radar field 26 overlap. In such an embodiment, the first radar 20 may have a different wavelength than the second radar 22 to avoid cross-interference. In this manner, the first radar 20 and the second radar 22 may reduce blind spots and monitor a larger area than a single radar could.

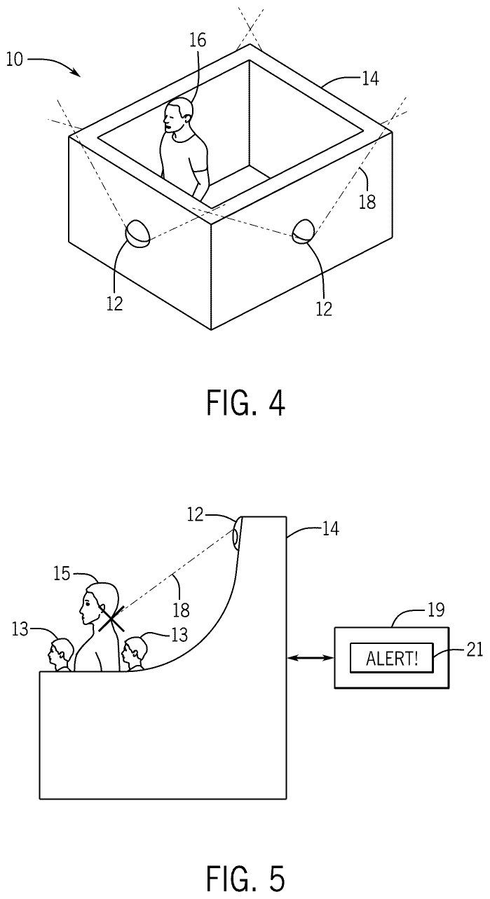

FIG. 4 is a perspective view of another embodiment of the guest detection system 10. In the pictured embodiment, the guest detection system 10 may include a ride vehicle 14 and at least one radar 12 coupled to the side of the ride vehicle 14 and directed so as to monitor an “exit” plane of the ride vehicle 14. In such an embodiment, the radar 12 may be positioned and oriented such that the radar field 18 extends parallel to the side of the ride vehicle 14 that the radar 12 is coupled to. The radar 12 coupled to the side of the ride vehicle 14 may be implemented in addition or as an alternative to a radar 12 coupled to the back interior wall of the ride vehicle. In the pictured embodiment, the restricted area comprises an area outside the walls of the ride vehicle 14 such as may be entered by a guest who is exiting the ride vehicle 14. Therefore, a guest 16 may breach the radar field 18 if any part of the guest 16 extends over any of the walls of the ride vehicle 14. For example, a guest 16 may breach the radar field 18 if the guest 16 sticks a hand out of the ride vehicle 14 to touch a set piece of the attraction.

In another embodiment, the ride vehicle 14 may not have walls. Instead, the ride vehicle 14 may comprise a series of seats and a series of restraints (e.g., bars, straps, and so forth). The radar 12 may be positioned and oriented such that the radar field 18 monitors the restricted area. The restricted area in such an embodiment may be any area where one or more guests 16 could not reach if the one or more guests were properly seated and restrained. For example, the radar 12 may be coupled to a bottom of each seat of the series of seats. The radar 12 may be positioned and oriented to emit the radio waves comprising the radar field 18 in a flat plane approximately one foot below the average height at which the feet of the one or more guests 16 dangle while seated in the ride vehicle 14. Therefore, the radar field 18 may be breached if the one or more guests are unseated and attempt to exit the ride vehicle 14.

FIG. 5 is a depiction of one example of the operation of the guest detection system 10. As depicted, the ride vehicle 14 may include at least one radar 12, wherein the radar 12 may emit radio waves corresponding to the radar field 18. The radar 12 may positioned and oriented such that the radar field 18 is roughly one foot above the average height of the one or more seated guests 13. In such a configuration, the radar field 18 may not be breached by the one or more seated guests 13 but only by a guest who is not properly in their seat. That is, the computing system may determine the radar field 18 has been breached by a standing guest 15.

The radar field 18 may comprise radio waves as discussed herein. When the radio waves are interrupted by an object, a portion of the radio waves may reverberate off the object and back toward the radar 12. The computing system may use the characteristics of the reverberated waves (e.g., strength or intensity, scatter pattern, time elapsed since emitting the reverberated waves) to determine the distance of the object from the radar 12, the size of the object, and other characteristics of the object (collectively, the characteristics of the object). In this manner, the computing system may determine that the radar field 18 was breached.

In some embodiments, the computing system may determine the radar field 18 was breached if the characteristics of the object are within or exceed one or more thresholds. The one or more thresholds may pertain to the distance of the object from the radar 12, the size of the object, the duration of the interruption, or any combination thereof. With regards to the one or more thresholds pertaining to distance, the computing system may be configured to ignore the object if the object is a specified distance from the radar 12, such as might correspond to the object being outside of the monitored field (e.g., attraction scenery or structure). For example, the system of FIG. 2 may include a threshold such that objects outside of the ride vehicle do not breach the radar field 18. As another example, the system of FIG. 4 may include a threshold of a particular height such that one or more guests 16 attempting to escape the ride vehicle 14 constitute an object breaching the radar field 18 but a ceiling of the attraction does not constitute an object breaching the radar field 18. With regards to the one or more thresholds pertaining to size, the computing system may be configured to ignore small objects, such as bugs, hats, balloons, and so forth, which likely do not correspond to a guest or portion of a guest. With regards to the one or more thresholds pertaining to duration of interruption, the computing system may be configured to ignore objects that interrupt the radar field for a short time, e.g., for example, less than 2 seconds, less than 1 second, less than 0.5 seconds, and so forth. For example, the computing system may ignore a hat flying off the ride vehicle 14 because the interruption caused by the hat is only a few seconds long or less.

In some embodiments, the guest detection system may comprise a user interface 19, wherein the user interface 19 is configured to display information for attraction staff (e.g., status information, notifications). The user interface 19 may be communicatively coupled to the attraction control system 30, the on-board control system 32, or both. If the computing system determines the radar field 18 was breached, the guest detection system 10 may output an alert 21 on the user interface 19. The alert 21 may comprise text describing the breach, an audible alert or alarm, and/or a video feed of the ride vehicle 14. The user interface 19 may be configured to allow the attraction staff to respond to the breach. For example, the user interface 19 may comprise a button that, when activated by the attraction staff, relays a message to the one or more guests 16 to remain seated. The user interface 19 may be configured to allow attraction staff to adjust the operation of the ride vehicle 14 or the attraction. For example, the attraction staff may slow the speed of the ride vehicle 14 via the user interface 19 in response to receiving an alert 21. As another example, if the ride vehicle 14 is collectively controlled, the attraction staff may stop the attraction via the user interface 19 in response to receiving an alert 21.

In some embodiments, the computing system may adjust the operation of the ride vehicle 14 or the attraction automatically if the computing system determines the radar field 18 has been breached. For example, the computing system may stop the ride vehicle 14 automatically in response to determining the radar field 18 was breached. In other embodiments, the computing system may slow the ride vehicle 14 down. In some embodiments, the computing system may stop any movement of the set piece of the attraction. By way of example, in some embodiments a breach of the radar field sufficiently in excess of the one or more thresholds (such as by an additional threshold amount) may cause the attraction control system 30, the on-board control system 32, or both to automatically circumvent the user notification and/or approval process so as to automatically stop the ride vehicle in question or all ride vehicles of the attraction (i.e., an emergency stop or shutdown).

In some embodiments, the computing system may be configured to determine a severity of the breach. The user interface 19 may be configured to display the severity of the breach. The computing system may automatically adjust the operation of the ride vehicle 14 or attraction in accordance with the severity of the breach. For example, the computing system may slow the ride vehicle 14 down rather than stopping the ride vehicle if the breach is of low severity, such as the one or more guests 16 standing up for a few seconds. But the computing system may stop the ride vehicle 14 and any movement of the set piece of the attraction if the breach is of high severity, such as the one or more guests standing up and moving across the ride vehicle 14 in an apparent attempt to exit the ride vehicle 14. Additionally and/or alternatively, the user interface 19 may be configured to display recommended actions based on the severity of the breach to the attraction staff.

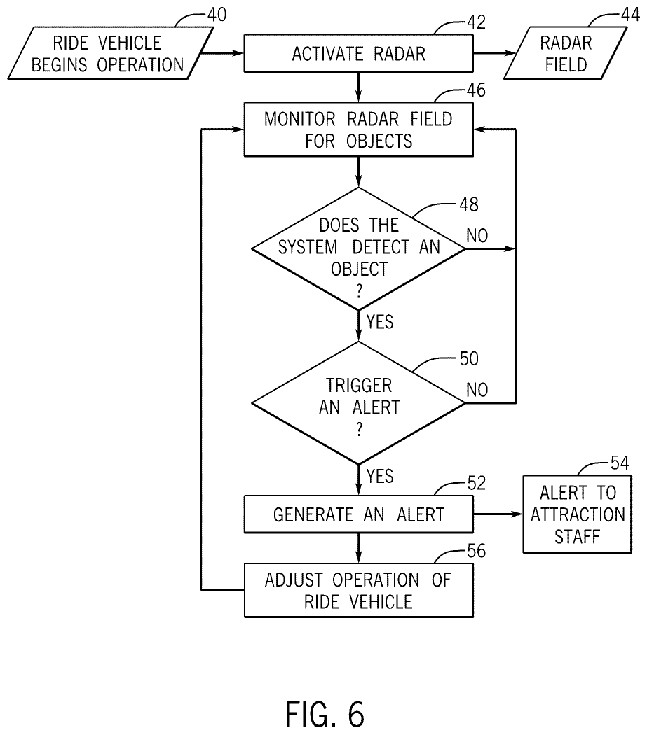

FIG. 6 is a flowchart of the operation of the guest detection system 10. In process block 42, the guest detection system 10 may activate the radar 12 when it receives an input 40. In some embodiments, activating the radar 12 includes causing the radar 12 to emit the radar field 18 as disclosed below. In some embodiments, the radar 12 continuously emits the radar field 18 and activating the radar 12 includes monitoring the radar field 18 for objects as disclosed below. In the pictured flowchart, the input 40 comprises an indication that the ride vehicle 14 has begun operation. But in other embodiments, the input 40 may comprise an indication that the attraction has begun operation. Alternatively, the input 40 may comprise an indication of a specified time occurring, receipt of a specified sensor signal, or a signal indicating the attraction staff has turned on the guest detection system 10 via the user interface.

The radar 12 may emit an output 44 (i.e., radio waves) comprising the radar field 18. The radar field 18 may be emitted as a continuous wave or as a series of pulses.

In process block 46, the guest detection system 10 may monitor the radar field 18 for objects. In decision block 48, the guest detection system 10 may determine if an object has been detected as breaching the radar field 18. The guest detection system 10 may determine an object has been detected if the radar 12 receives reverberated waves indicative of an object in the monitored area. If the guest detection system has not detected an object, the guest detection system 10 repeats process block 46 (i.e., continues the monitoring process).

If the radar field is breached, the guest detection system 10 may decide in decision block 50 whether the breach triggers an alert. To make this decision, the guest detection system 10 may analyze the reverberated radio waves received by the radar 12 to determine the characteristics of the object (e.g., size, location, and so forth) and/or of the breach (e.g., location, duration, and so forth). The guest detection system 10 may then compare the characteristics of the object and/or breach to one or more thresholds to determine whether the characteristics result in an acceptable (i.e., an alert is not justified) or an unacceptable (i.e., an alert is justified) breach. For example, if the size of the object exceeds a respective size alert threshold (e.g., the object is too large to be considered incidental), the guest detection system 10 may determine the breach is unacceptable and generate an alert (block 52). Conversely, if the size of the object is below the alert threshold, the system 10 may return to a monitoring state with no alert being generated. As another example, if the location of the breach is outside of a ride vehicle 14, the guest detection system 10 may determine the breach is unacceptable and generate an alert (block 52). As a further example, if the duration of the breach exceeds a respective duration alert threshold (e.g., the breach lasts for too long), the guest detection system 10 may determine the breach is unacceptable and generate an alert (block 52). In some implementations, the guest detection system 10 may trigger an alert if one or more than one of the characteristics result in an unacceptable breach as determined based on the respective alert thresholds for the respective measured characteristics. If the breach determined at decision block 48 is determined to be acceptable (i.e., not sufficient to trigger an alert) based on the observed characteristics, the guest detection system 10 may ignore the breach and repeat process block 46.

If the guest detection system determines that the breach determined at decision block 48 violates one or more respective alert thresholds, the guest detection system 10 may generate an alert 21 in process block 52, resulting in output 54 comprising the alert 21 to the attraction staff. By way of example, if one or more of the size of object breaching the radar field, the duration of the breach event, the location of the breach relative to a ride vehicle, and so forth violate a corresponding alert threshold for the characteristic, an alert is generated (block 52). The guest detection system may display the alert 21 to the attraction staff via the user interface 19.

In process block 56, the guest detection system 10 may adjust the operation of the ride vehicle 14. Adjusting the operation of the ride vehicle may comprise slowing down or stopping the ride vehicle 14. Additionally or alternatively, the guest detection system 10 may adjust the operation of the attraction. Adjusting operation of the attraction may comprise slowing down the plurality of ride vehicles, stopping the plurality of ride vehicles, and/or stopping any movements of the set piece. The guest detection system 10 may adjust the operation of the ride vehicle 14 and/or attraction automatically upon determining the radar field 18 was breached. In some embodiments, the user interface 19 may be configured to allow the attraction staff to adjust the operation of the ride vehicle 14 and/or attraction in response to the alert 21. After adjusting the operation of the ride vehicle 14, the guest detection system 10 may repeat process block 46 such that the guest detection system 10 continues to monitor the radar field 18 for objects as the ride vehicle 14 continues operating.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function). . . ”, it is intended that such elements are to be interpreted under 35 U.S.C. 112(f). However, for any claims containing elements designated in any other manner, it is intended that such elements are not to be interpreted under 35 U.S.C. 112(f).

1. A system comprising:
a ride vehicle;
at least one radar, wherein the at least one radar is configured to emit a radar field and wherein the at least one radar is positioned and oriented such that the radar field monitors a restricted area; and
a computing system configured to communicate with the at least one radar, wherein the computing system is programmed to:
detect whether there is a breach in the radar field; and
adjust an operation of the ride vehicle in response to a detected breach in the radar field.

2. The system of claim 1, further comprising a user interface in communication with the computing system, wherein the user interface is configured to display at least status information generated by the computing system or notification, or alerts generated by the computing system.

3. The system of claim 2, wherein the computing system is programmed to:
cause an alert to be displayed on the user interface in response to the detected breach; and
adjust the operation of the ride vehicle based on an input received via the user interface.

4. The system of claim 1, wherein the computing system is programmed to adjust the operation of the ride vehicle automatically.

5. The system of claim 1, wherein the at least one radar is coupled to or integral with the ride vehicle.

6. The system of claim 1, wherein the restricted area encompasses an area outside of the ride vehicle.

7. The system of claim 1, wherein the breach comprises an intrusion of an object into the radar field exceeding at least one threshold.

8. The system of claim 1, wherein adjusting the operation of the ride vehicle comprises stopping the ride vehicle.

9. The system of claim 1, wherein the ride vehicle comprises a slope and the at least one radar is positioned and oriented such that the radar field is parallel with the slope.

10. A method comprising:
activating, via a processor of a computing system, a radar, wherein the radar is configured to emit radio waves comprising a radar field;
monitoring, via the processor, the radar field for a breach;
determining, via the processor, the radar field is breached by an object; and
adjusting, via the processor, an operation of a ride vehicle based on the determination.

11. The method of claim 10, further comprising:
generating via the processor, an alert; and
displaying via the processor, the alert on a user interface.

12. The method of claim 11, further comprising:
determining, via the processor, a severity of the breach;
determining, via the processor, recommended actions to adjust the operation of the ride vehicle based on the severity of the breach; and
displaying, via the processor, recommended actions on the user interface.

13. The method of claim 10, further comprising:
determining via the processor, that characteristics of the object are within a threshold used to assess presence or absence of the breach.

14. The method of claim 13, wherein determining that characteristics of the object are within a threshold comprises:
determining, via the processor, a distance of the object from the radar;
comparing, via the processor, the distance of the object to the threshold; and
determining, via the processor, the distance of the object does not exceed the threshold.

15. The method of claim 13, wherein determining that characteristics of the object fall within a threshold comprise:
determining, via the processor, a size of the object;
comparing, via the processor, the size of the object to the threshold; and
determining, via the processor, the size of the object exceeds the threshold.

16. The method of claim 10, further comprising:
determining, via the processor, a severity of the breach; and
determining, via the processor, how to adjust the operation of the ride vehicle based on the severity of the breach; and
automatically adjusting, via the processor, the operation of the ride vehicle.

17. The method of claim 10, comprising:
activating, via the processor, the radar when the ride vehicle begins operation.

18. The method of claim 11, comprising:
activating, via the processor, the radar upon receiving an input from the user interface.

19. A system comprising:
a ride vehicle;
a first radar coupled to the ride vehicle, wherein the first radar is configured to emit a first radar field;
a second radar coupled to the ride vehicle, wherein the second radar is configured to emit a second radar field; and
a computing system in communication with the first radar and the second radar, wherein the computing system is programmed to:
detect whether there is a breach in at least the first radar field or the second radar field; and
adjust an operation of the ride vehicle when the breach is detected.

20. The system of claim 19, wherein the first radar and the second radar are positioned and oriented such that the first radar field and the second radar field are overlapping and wherein a wavelength of the first radar field is different than a wavelength of the second radar field.
